(19) United States
(12) Patent Application Publication
(10) Pub. No.: US 2023/0290282 A1
(43) Pub. Date: Sep. 14, 2023

(54) DIGITAL SIGNAGE SYSTEM, INFORMATION TERMINAL, AND DIGITAL SIGNAGE DEVICE

(71) Applicant: SHARP KABUSHIKI KAISHA, Sakai City (JP)

(72) Inventors: MASAFUMI OKIGAMI, Sakai City (JP); KANAME MATSUI, Sakai City (JP)

(21) Appl. No.: 18/117,111

(22) Filed: Mar. 3, 2023

(30) Foreign Application Priority Data
Mar. 11, 2022 (JP) 2022-038439

(51) Int. Cl. G09F 9/30; H04L 9/40

(52) U.S. Cl. CPC G09F 9/30; H04L 63/08

(57) ABSTRACT

This digital signage system includes an information terminal and a digital signage device. The digital signage device includes a storage, a transmitter, a content acquirer, a display, and a display controller. The storage stores therein identification information of the digital signage device. The transmitter transmits the identification information to the information terminal. The display controller causes the display to display an image based on the acquired content data. The information terminal includes a receiver, an authenticator, and a relay. The receiver receives the identification information transmitted from the digital signage device. The authenticator authenticates the digital signage device using the received identification information. Upon the digital signage device being authenticated by the authenticator, the relay relays communication between a content server and the digital signage device. The content acquirer acquires content data corresponding to the identification information from the content server via the relay.

### INCORPORATION BY REFERENCE

This application claims the priority based on Japanese Patent Application No. 2022-038439 filed on Mar. 11, 2022 under 35 U.S.C. 119. The contents of this application are incorporated herein by reference in their entirety.

### BACKGROUND

The present disclosure relates to a digital signage system, an information terminal, and a digital signage device.

A general digital signage delivery system has been developed for delivering content to digital signage displays. In this digital signage delivery system, each digital signage display, which is connected to a Fiber To Home (FTTH) line, receives content from a content delivery server via the FTTH line and displays the received content. The content delivery server acquires user information from a mobile terminal around the digital signage display and delivers, to the digital signage display, content suitable for users in the vicinity of the digital signage display.

### SUMMARY

A digital signage system according to an aspect of the present disclosure includes an information terminal and a digital signage device. The digital signage device includes a storage, a transmitter, a content acquirer, a display, and a display controller. The storage stores therein identification information of the digital signage device. The transmitter transmits the identification information to the information terminal. The content acquirer acquires content data via the information terminal. The display controller causes the display to display an image based on the acquired content data. The information terminal includes a receiver, an authenticator, and a relay. The receiver receives the identification information transmitted from the digital signage device. The authenticator authenticates the digital signage device using the received identification information. The relay communicatively connects to an external content server and the digital signage device, and relays communication between the external content server and the digital signage device. Upon the digital signage device being authenticated by the authenticator, the relay relays communication between the content server and the digital signage device. The content acquirer acquires content data corresponding to the identification information from the external content server via the relay.

An information terminal according to another aspect of the present disclosure includes a receiver, an authenticator, and a relay. The receiver receives identification information transmitted form a digital signage device. The identification information identifies the digital signage device. The authenticator authenticates the digital signage device using the received identification information. The relay communicatively connects to an external content server and the digital signage device, and relays communication between the external content server and the digital signage device. Upon the digital signage device being authenticated by the authenticator, the relay relays a download of content data from the external content server to the digital signage device.

A digital signage device according to another aspect of the present disclosure includes a storage, a transmitter, a content acquirer, a display, and a display controller. The storage stores therein identification information of the digital signage device. The transmitter transmits the identification information to the information terminal. The content acquirer acquires content data via the information terminal. The display controller causes the display to display an image based on the acquired content data. Upon the digital signage device being authenticated by the information terminal based on the identification information, the content acquirer is communicatively connected to the information terminal and acquires content data corresponding to the identification information from an external content server via the information terminal.

### BRIEF DESCRIPTION OF THE DRAWINGS

FIG. 1 is a schematic diagram illustrating a configuration of a digital signage system according to an embodiment.

FIG. 2A is a block diagram illustrating a schematic configuration of a content server shown in FIG. 1.

FIG. 2B is a diagram illustrating an example of a data structure of a content database.

FIG. 3 is a block diagram illustrating a schematic configuration of an information terminal shown in FIG. 1.

FIG. 4 is a block diagram illustrating a schematic configuration of a digital signage display shown in FIG. 1.

FIG. 5 is a diagram showing an operation flow of a content delivery system according to an embodiment.

FIG. 6A is a schematic diagram illustrating an example of a content management screen for logging into a content server.

FIG. 6B is a schematic diagram illustrating an example of the content management screen having a content list displayed thereon.

### DETAILED DESCRIPTION

The following describes a digital signage system according to an embodiment with reference to the accompanying drawings. Elements in the drawings that are the same or equivalent are marked by the same reference signs, and description of such elements is not repeated.

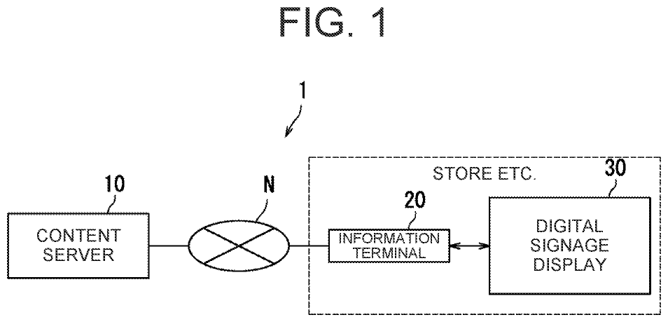

FIG. 1 is a schematic diagram illustrating a configuration of a digital signage system 1 according to the present embodiment. As illustrated in FIG. 1, the digital signage system 1 includes a content server 10, an information terminal 20, and a digital signage display 30 (an example of what is referred to as a digital signage device). For convenience of explanation, FIG. 1 shows a case where the digital signage system 1 includes a single digital signage display 30. However, the digital signage system 1 may include a plurality of digital signage displays 30 installed in the same place or in different places.

The content server 10 is connected to the Internet N and delivers advertising content. The information terminal 20 is, for example, a mobile communication terminal such as a smart phone and is connectable to the Internet N through mobile communication. The digital signage display 30 is installed in a place such as a store and displays advertising content. In the present embodiment, the place where the digital signage display 30 is installed is not with a communication environment for the digital signage display 30 to directly connect to the Internet N. The following specifically describes a configuration for displaying new advertising content on the digital signage display 30 and changing currently displayed advertising content.

Content Server 10

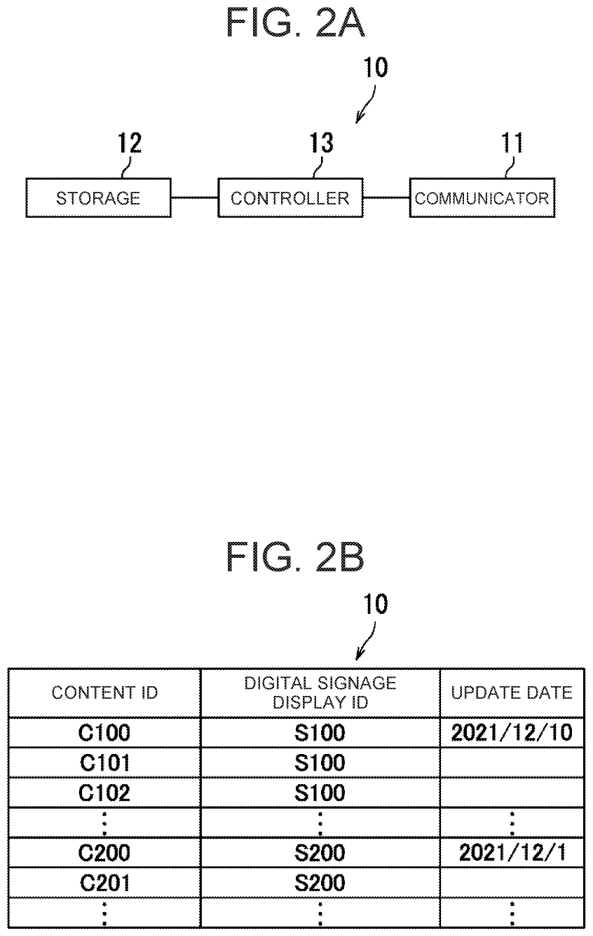

FIG. 2A is a block diagram illustrating a schematic configuration of the content server 10 shown in FIG. 1. As illustrated in FIG. 2A, the content server 10 includes a communicator 11, a storage 12, and a controller 13.

The communicator 11 is a communication interface such as a LAN connectable to the Internet N. Under the control of the controller 13, the communicator 11 connects to the Internet N and exchanges data with the information terminal 20 via the Internet N.

The storage 12 includes a non-volatile storage medium such as a hard disk. In the storage 12, various data such as image data of advertising content (referred to below as content data) and a content database (referred to below as a content DB) 120 is stored. The content DB 120 is a database for managing advertising content on a per-digital signage display basis. FIG. 2B is a diagram illustrating an example of a data structure of the content DB 120.

As shown in FIG. 2B, the content DB 120 contains pieces of data each indicating, for example, a content ID, a digital signage display ID, and an update date in association with one another. The content ID is identification information for uniquely identifying content and is associated with content data stored in the storage 12. The content ID may be a name representing the corresponding content or a version of the content. The digital signage display ID is identification information for uniquely identifying a digital signage display 30. The digital signage display ID may be, for example, a name or a number representing the digital signage display. The update date is a date of delivery of the content data to the corresponding digital signage display 30.

Furthermore, for each digital signage display, a digital signage display ID and a password are prestored in the storage 12 as login information for the content server 10.

The controller 13 includes a central processing unit (CPU), read only memory (ROM), and random access memory (RAM). The controller 13 controls the components of the content server 10 through the CPU executing control programs stored in the ROM and the storage 12. Specifically, the controller 13 acquires LOGIN INFORMATION from the information terminal 20 and determines permission or denial of access (login). The controller 13 also transmits, based on the login information, the corresponding content data to the information terminal 20.

Information Terminal 20

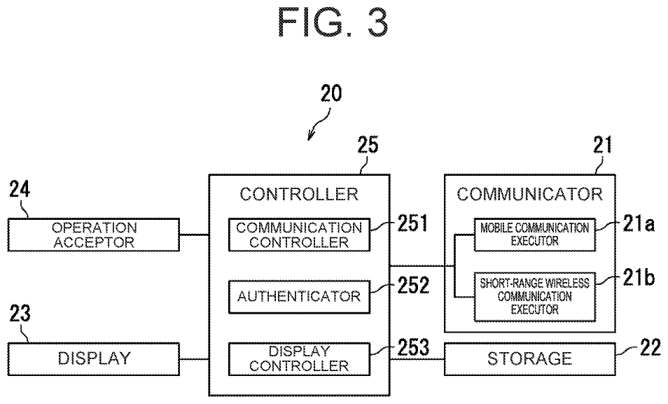

FIG. 3 is a block diagram illustrating a schematic configuration of the information terminal 20 shown in FIG. 1. As illustrated in FIG. 3, the information terminal 20 includes an operation receiver, a receiver, an authenticator, a relay, a communicator 21, a storage 22, a display 23, an operation acceptor 24, and a controller 25.

The operation receiver receives a user operation.

The receiver receives identification information transmitted from the digital signage display 30.

The authenticator authenticates the digital signage display 30 using the received identification information.

The relay communicatively connects to the content server 10, which is an external server, and the digital signage display 30 to relay communication between the external content server 10 and the digital signage display 30.

The relay communicatively connects to the external content server 10 through mobile communication and communicatively connects to the digital signage display 30 through wireless communication that has a faster communication speed than short-range wireless communication.

Upon the digital signage display 30 being authenticated by the authenticator, the relay relays communication between the external content server 10 and the digital signage display 30. Then, a content acquirer 352 acquires content data corresponding to the identification information from the external content server 10 via the relay.

The relay communicatively connects to the external content server 10 in accordance with a user operation received by the operation receiver and relays a download of the content data from the external content server 10 to the content acquirer 352.

Upon the digital signage display 30 being authenticated by the authenticator, the relay relays a download of the content data from the external content server 10 to the digital signage display 30.

The communicator 21 includes a mobile communication executor 21a and a short-range wireless communication executor 21b. The mobile communication executor 21a includes a communication interface for mobile communication such as 5G or LTE. Under the control of the controller 25, the mobile communication executor 21a connects to a corresponding radio access network, connects to a core network via the radio access network, and connects to the Internet N via the core network. The mobile communication executor 21a communicates with the content server 10 connected to the Internet N.

The short-range wireless communication executor 21b includes a communication interface for wireless communication via Bluetooth (registered trademark) (referred to below as Bt communication) and wireless LAN communication via, for example, Wi-Fi (IEEE802.11n, IEEE802.11ac, IEEE802.11ax). The short-range wireless communication executor 21b communicates with the digital signage display 30 through Bt communication and wireless LAN communication under the control of the controller 25.

The storage 22 is a non-volatile storage medium such as flash memory. In the storage 22, application programs and various data such as user data are stored. The application programs include, for example, a content management program for managing advertising content.

The display 23 includes a display panel and a drive circuit that drives the display panel, both of which are not shown. The drive circuit supplies a drive signal indicating an image to be displayed to the display panel under the control of the controller 25. The display panel is driven in response to the drive signal supplied by the drive circuit and displays the image according to the drive signal.

The operation acceptor 24 includes a touch panel (not shown). The touch panel is provided on the display 23. The operation acceptor 24 accepts a user operation and outputs information indicating the accepted operation to the controller 25.

The controller 25 includes a CPU and memory (ROM and RAM). The controller 25 functions as a communication controller 251 (an example of the relay), the authenticator 252, and a display controller 253, and controls the components of the information terminal 20 through the CPU executing control programs stored in the ROM and the storage 22.

The communication controller 251 controls the mobile communication executor 21a and the short-range wireless communication executor 21b to relay communication between the content server 10 and the digital signage display 30 in accordance with a user operation. That is, the communication controller 251 has a so-called tethering function. Specifically, the communication controller 251 establishes a Bt communication connection with the digital signage display 30 in accordance with a user operation. The communication controller 251 establishes a wireless LAN connection with the digital signage display 30 in accordance with a result of the authentication by the authenticator 252. The communication controller 251 connects to the content server 10 through mobile communication and transfers content data delivered from the content server 10 to the digital signage display 30 through wireless LAN communication. In the present embodiment, the communication speed of the wireless LAN communication is faster than that of the Bt communication.

The authenticator 252 acquires the digital signage display ID from the digital signage display 30 for a wireless LAN connection to the digital signage display 30 and authenticates the acquired digital signage display ID. The authentication of the digital signage display ID for a wireless LAN connection is performed by checking the digital signage display ID acquired during pairing.

The display controller 253 causes the display 23 to display an image. Specifically, the display controller 253 causes the display 23 to display a content management screen in response to a content management program being started. Details of the content management screen are described below.

Digital Signage Display 30

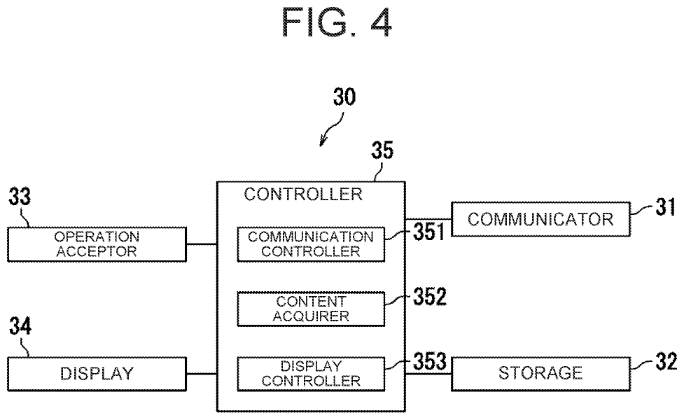

FIG. 4 is a block diagram illustrating a schematic configuration of the digital signage display 30 shown in FIG. 1. As illustrated in FIG. 4, the digital signage display 30 includes a communicator 31, a storage 32, a transmitter, the content acquirer, a display controller, an operation acceptor 33, a display 34, and a controller 35.

The communicator 31 includes a communication interface for wireless communication via Bluetooth (registered trademark) (referred to below as Bt (registered trademark) communication) and wireless LAN communication via, for example, Wi-Fi (IEEE802.11n, IEEE802.11ac, IEEE802.11ax). The communicator 31 communicates with the information terminal 20 through Bt communication and wireless LAN communication under the control of the controller 35.

The storage 32 includes a non-volatile storage medium such as a hard disk. In the storage 32, application programs and various data such as content data are stored. The application programs include a program for delivering advertising content (referred to below as a content delivery program). Identification information of the digital signage display 30 is stored in the storage 32.

The operation acceptor 33 includes, for example, operation buttons, a keyboard, and a mouse, all of which are not shown.

The controller 35 includes a CPU and memory (ROM and RAM). The controller 35 functions as a communication controller 351, the content acquirer 352, and a display controller 353 through the CPU executing control programs stored in the ROM and the storage 32.

The communication controller 351 controls the communicator 31 to communicate with the information terminal 20. Specifically, the communication controller 351 controls the communicator 31 to perform Bt communication or wireless LAN communication with the information terminal 20 in accordance with a user operation.

The transmitter transmits the identification information to the information terminal 20.

The content acquirer 352 acquires content data transferred from the information terminal 20 through wireless LAN communication and stores the acquired content data in the storage 32.

The display controller 353 causes the display 34 to display an image based on the content data stored in the storage 32 in accordance with a user operation.

Upon the digital signage display 30 being authenticated by the information terminal 20 based on the identification information, the content acquirer 352 is communicatively connected to the information terminal 20 and acquires content data corresponding to the identification information from the external content server 10 via the information terminal 20.

Operation

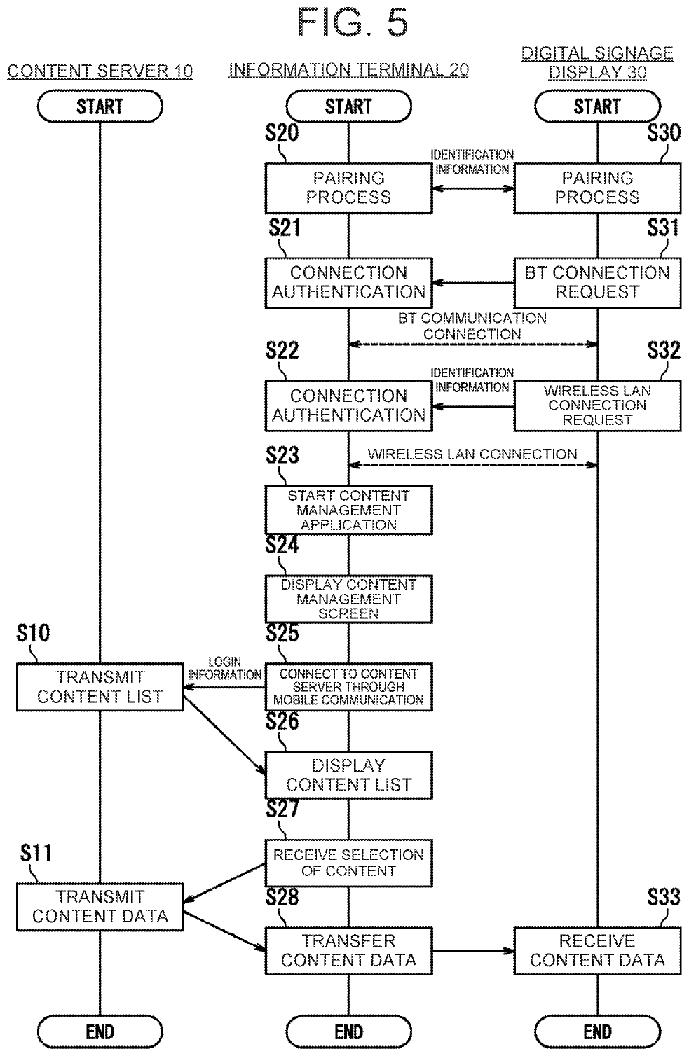

The following describes operation of the digital signage system 1 with reference to FIG. 5. FIG. 5 is a diagram showing an operation flow of the digital signage system 1 according to the present embodiment.

First, a user performs, as a setup process, an operation of establishing pairing between the information terminal 20 and the digital signage display 30 through short-range wireless communication.

The transmitter transmits identification information through short-range wireless communication.

The receiver receives the identification information through short-range wireless communication.

Upon receiving a pairing operation via the operation acceptor 24, the information terminal 20 performs a pairing process via the communicator 21 (Step S20). Upon receiving a pairing operation via the operation acceptor 33, the digital signage display performs a pairing process via the communicator 31 (Step S30).

More specifically, the communication controller 251 of the information terminal 20 controls the short-range wireless communication executor 21b to perform Bt communication with the digital signage display 30, thereby transmitting a pairing request including identification information of the information terminal 20 to the digital signage display 30.

The communication controller 351 of the digital signage display 30 controls the communicator 31 to perform Bt communication with the information terminal 20, thereby transmitting a pairing response including the digital signage display ID of the digital signage display 30 to the pairing request from the information terminal 20.

The communication controller 251 of the information terminal 20 controls the short-range wireless communication executor 21b to receive the pairing response from the digital signage display 30, thereby storing, in the storage 22, the digital signage display ID included in the pairing response.

After the setup process, in a case where the user wishes to display new content on the digital signage display 30, the user brings the information terminal 20 close to the digital signage display 30 to establish a Bt communication connection between the information terminal 20 and the digital signage display 30.

Specifically, the communication controller 351 of the digital signage display 30 transmits a Bt communication connection request including the digital signage display ID to the information terminal 20 via the communicator 31 (Step S31).

The information terminal 20 receives the Bt communication connection request from the digital signage display 30 via the short-range wireless communication executor 21b and conducts connection authentication (Step S21). That is, the communication controller 251 of the information terminal 20 checks the digital signage display ID included in the Bt communication connection request received via the short-range wireless communication executor 21b against the digital signage display ID in the storage 22. If the received digital signage display ID matches the digital signage display ID in the storage 22, the communication controller 251 of the information terminal 20 establishes a Bt communication connection with the digital signage display 30 via the short-range wireless communication executor 21b.

After the Bt communication connection between the information terminal 20 and the digital signage display 30 has been established, the user establishes a wireless LAN connection of the digital signage display 30 to the information terminal 20 by starting a content delivery application in the digital signage display 30.

The communication controller 351 of the digital signage display 30 receives the operation of starting the content delivery application via the operation acceptor 24 and controls the communicator 31 to transmit a wireless LAN connection request including the digital signage display ID to the information terminal 20 through wireless LAN communication (Step S32).

Upon receiving the wireless LAN connection request from the digital signage display 30 via the short-range wireless communication executor 21b, the authenticator 252 of the information terminal 20 authenticates the digital signage display 30 (Step S22). Specifically, the authenticator 252 determines whether or not the digital signage display ID included in the wireless LAN connection request matches the digital signage display ID of the digital signage display 30 in Bt communication connection with the information terminal 20. Upon the authenticator 252 determining that the digital signage display IDs match, the communication controller 251 establishes a wireless LAN connection with the digital signage display 30 via the short-range wireless communication executor 21b.

After the wireless LAN connection between the information terminal 20 and the digital signage display 30 has been established, the user performs an operation of starting a content management application in the information terminal 20. The information terminal 20 starts a content management application program (Step S23) and displays a content management screen on the display 23 (Step S24). Specifically, upon receiving the operation of starting the content management application via the operation acceptor 24, the display controller 253 of the information terminal 20 executes the content management application program in the storage 22 and displays the content management screen on the display 23.

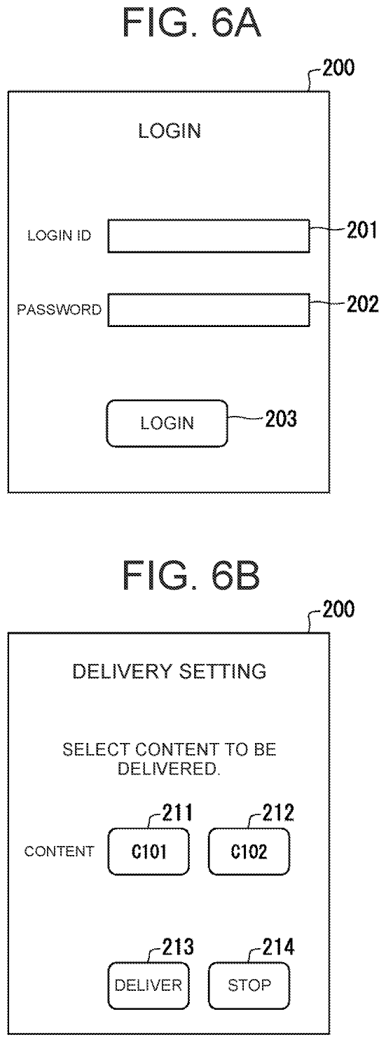

FIG. 6A is a schematic diagram illustrating an example of a content management screen 200. More specifically, FIG. 6A is a schematic diagram illustrating an example of the content management screen 200 for the user to log into the content server 10. As illustrated in FIG. 6A, input fields 201 and 202, and a login button 203 are displayed on the content management screen 200. The input fields 201 and 202 are interfaces where login information (a login ID and a password) for logging into the content server 10 are received. The login button 203 is an interface where an instruction to transmit the login information to the content server 10 is received. The input field 201 receives input of a digital signage display ID, and the input field 202 receives input of a password corresponding to the digital signage display ID.

Upon receiving an operation of pressing the login button 203 on the content management screen 200 via the operation acceptor 24, the information terminal 20 accesses the content server 10 through mobile communication (Step S25). More specifically, the communication controller 251 of the information terminal 20 controls the mobile communication executor 21a to connect to the Internet N through mobile communication, thereby transmitting the login information to the content server 10 and accessing the content server 10.

The content server 10 transmits a content list via the communicator 11 based on the login information from the information terminal 20 (Step S10).

Specifically, the controller 13 of the content server 10 acquires the login information transmitted from the information terminal 20 via the communicator 11 and checks the acquired login information against the login information stored in the storage 12. The controller 13 permits login of the information terminal 20 if the acquired login information is included in the login information stored in the storage 12. If the acquired login information is not included in the login information stored in the storage 12, the controller 13 transmits, to the information terminal 20, a message indicating that the login has been denied.

The controller 13 then transmits, to the information terminal 20 via the communicator 11, data of the content list containing non-updated content IDs that correspond to the digital signage display ID included in the login information and that have been extracted from the content DB 120 (FIG. 2B). The non-updated content IDs refer to content IDs for which no date has been entered in “Update date” cells in FIG. 2B, which in other words are undelivered content IDs. For example, in a case where the digital signage display ID of the digital signage display 30 is “5100”, content IDs “C101” and “C102” are transmitted to the information terminal 20 as the content list.

The information terminal 20 acquires the data of the content list from the content server 10 via the mobile communication executor 21a, and displays the acquired data of the content list on the content management screen 200 via the display controller 253 (Step S26).

FIG. 6B is a schematic diagram illustrating an example of the content management screen 200 having the content list displayed thereon. As shown in FIG. 6B, icons 211 to 214 are displayed on the content management screen 200. The icons 211 and 212 correspond to the undelivered content IDs “C101” and “C102”, and receive selection of the respective content IDs. The icon 213 receives an instruction to deliver content data corresponding to a selected one of the icons 211 and 212. The icon 214 receives an instruction to stop delivery of content data. Hereinafter, the icons 211 and 212 may be referred to as content icons, the icon 213 as a delivery icon, and the icon 214 as a delivery stop icon.

The information terminal 20 receives, via the operation acceptor 24, selection of content to be delivered (Step S27). That is, the information terminal 20 receives selection of the content icon 211 and an operation of pressing the delivery icon 213 via the operation acceptor 24. The communication controller 251 of the information terminal 20 transmits, to the content server 10 via the mobile communication executor 21a, the content ID corresponding to the content icon 211 selected and received.

The content server 10 acquires the content ID from the information terminal 20 via the communicator 11 and transmits the content data corresponding to the acquired content ID to the information terminal 20 (Step S11). That is, the controller 13 of the content server 10 reads the content data corresponding to the acquired content ID out of the storage 12, encodes or otherwise converts the content data, and transmits the content data to the information terminal 20 in packets. The controller 13 then enters the date of the transmission of the content data in the content DB 120 as an update date corresponding to the acquired content ID.

The information terminal 20 receives the content data transmitted from the content server 10 via the mobile communication executor 21a and transfers the received content data to the digital signage display 30 via the short-range wireless communication executor 21b (Step S28). That is, the communication controller 251 of the information terminal 20 receives the content data in packets via the mobile communication executor 21a. The communication controller 251 then controls the short-range wireless communication executor 21b to transmit the received packets of the content data to the digital signage display 30 through wireless LAN communication. That is, the information terminal 20 relays the delivery of the content data from the content server 10 to the digital signage display 30.

The digital signage display 30 receives the content data transmitted from the information terminal 20 via the communicator 31 (Step S33). That is, the content acquirer 352 of the digital signage display 30 acquires, via the communicator 31, the packets of the content data transmitted from the information terminal 20 through wireless LAN communication. The content acquirer 352 then decrypts or otherwise converts the acquired packets of the content data and stores the content data in the storage 32. That is, the digital signage display 30 downloads the content data from the content server 10 via the information terminal 20 in wireless LAN connection with the digital signage display 30.

After the content data has been downloaded to the digital signage display 30, the communication controller 351 of the digital signage display 30 terminates the wireless LAN connection with the information terminal 20 in accordance with an operation of terminating the content delivery application by the user. The information terminal 20 terminates the wireless LAN connection with the digital signage display 30 as a result of the digital signage display 30 terminating the wireless LAN connection.

After the content data has been downloaded to the digital signage display 30, the communication controller 251 of the information terminal 20 transmits a logout request including the digital signage display ID to the content server 10 via the mobile communication executor 21a in accordance with an operation of terminating the content management application by the user. Upon the content server 10 receiving the logout request from the information terminal 20 via the communicator 11, the controller 13 logs out the digital signage display ID included in the logout request. This disconnects the mobile communication connection between the information terminal 20 and the content server 10.

After the content data has been downloaded to the digital signage display 30, the user performs an operation of reproducing the content data. Upon the digital signage display 30 receiving the operation of reproducing the downloaded content data via the operation acceptor 33, the display controller 353 reads the content data specified by the received reproduction operation out of the storage 32 and displays an image based on the content data on the display 34.

It should be noted that for stopping the delivery of the content data (Step S11), the user presses the delivery stop icon 214 on the content management screen 200 shown in FIG. 6B. Upon the information terminal 20 receiving the operation of pressing the delivery stop icon 214, the communication controller 251 transmits, to the content server 10 via the mobile communication executor 21a, delivery stop information indicating discontinuation of the delivery of the content data. Upon the information terminal 20 receiving the operation of pressing the delivery stop icon 214, the communication controller 251 stops transferring the content data to the digital signage display 30 through wireless LAN communication.

Upon the content server 10 receiving the delivery stop information from the information terminal 20 via the communicator 11, the controller 13 stops transmitting the content data to the information terminal 20 and deletes, from the content DB 120, the update date of the content data that has been stopped being delivered.

According to the foregoing embodiment, even a digital signage display 30 that is not in a communication environment allowing direct connection to the Internet N can download content data from the content server 10 connected to the Internet N via the information terminal 20 that has authenticated the digital signage display 30 and that has been authenticated by the digital signage display 30. It is therefore possible to reproduce corresponding content on the digital signage display 30 as appropriate while keeping communication costs low.

Furthermore, according to the foregoing embodiment, a wireless LAN connection is established between the digital signage display 30 and the information terminal 20 that are in Bt communication connection with each other. It is therefore possible to safely download content data to the digital signage display 30.

Furthermore, according to the foregoing embodiment, the content server 10 manages the update state of content for each digital signage display 30, and the user can recognize, via the information terminal 20, content that has not been delivered to the corresponding digital signage display 30. Thus, the user can appropriately download necessary content to each digital signage display 30 via the information terminal 20.

An embodiment of the present disclosure has been described above. However, the present disclosure is not limited to the embodiment described above and may be implemented in various different forms that do not deviate from the gist of the present disclosure. The drawings schematically illustrate elements of configuration mainly in order to facilitate understanding, and properties of elements of configuration illustrated in the drawings, such as thickness, length, and number thereof, may differ from actual properties thereof in order to facilitate preparation of the drawings. Furthermore, properties of elements of configuration described in the foregoing embodiment, such as shapes and dimensions, are merely examples and are not intended as specific limitations. Various alterations may be made so long as there is no substantial deviation from the effects of the present disclosure. The following describes modification examples of the foregoing embodiment.

### Modification Examples

(1) In the storage 12 of the content server 10, the content DB 120 and content data may be updated at any time by a content manager via another terminal (not shown) in communicative connection with the content server 10. That is, with respect to the content DB 120 and content data in the storage 12, processing such as entry of new content or deletion of content that has been stored for more than a certain period of time may be performed at any time.

(2) Communication between the content server 10 and the digital signage display 30 may be relayed by establishing a Bt communication connection of the digital signage display 30 to the information terminal 20 instead of establishing a wireless LAN connection of the digital signage display 30 to the information terminal 20. That is, the information terminal 20 may access the content server 10 through mobile communication and transfer content data delivered from the content server 10 to the digital signage display 30 through Bt communication while in Bt communication connection with the digital signage display 30.

1. A digital signage system comprising an information terminal and a digital signage device,
the digital signage device including:
a storage that stores therein identification information of the digital signage device;
a transmitter that transmits the identification information to the information terminal;
a content acquirer that acquires content data via the information terminal;
a display; and
a display controller that causes the display to display an image based on the acquired content data,
the information terminal including:
a receiver that receives the identification information transmitted from the digital signage device;
an authenticator that authenticates the digital signage device using the received identification information; and
a relay that communicatively connects to an external content server and the digital signage device, and relays communication between the external content server and the digital signage device, wherein
upon the digital signage device being authenticated by the authenticator, the relay relays communication between the external content server and the digital signage device, and the content acquirer acquires content data corresponding to the identification information from the external content server via the relay.

2. The digital signage system according to claim 1, wherein
pairing is preliminarily established between the information terminal and the digital signage device through short-range wireless communication,
the transmitter transmits the identification information through the short-range wireless communication, and
the receiver receives the identification information through the short-range wireless communication.

3. The digital signage system according to claim 2, wherein the relay communicatively connects to the external content server through mobile communication and communicatively connects to the digital signage device through wireless communication that has a faster communication speed than the short-range wireless communication.

4. The digital signage system according to claim 1, wherein
the information terminal further includes an operation receiver that receives a user operation, and
the relay communicatively connects to the external content server in accordance with the user operation received by the operation receiver and relays a download of the content data from the external content server to the content acquirer.

5. An information terminal comprising:
a receiver that receives identification information transmitted form a digital signage device, the identification information identifying the digital signage device;
an authenticator that authenticates the digital signage device using the received identification information; and
a relay that communicatively connects to an external content server and the digital signage device, and relays communication between the external content server and the digital signage device, wherein
upon the digital signage device being authenticated by the authenticator, the relay relays a download of content data from the external content server to the digital signage device.

6. A digital signage device comprising:
a storage that stores therein identification information of the digital signage device;
a transmitter that transmits the identification information to an information terminal;
a content acquirer that acquires content data via the information terminal;
a display; and
a display controller that causes the display to display an image based on the acquired content data, wherein
upon the digital signage device being authenticated by the information terminal based on the identification information, the content acquirer is communicatively connected to the information terminal and acquires content data corresponding to the identification information from an external content server via the information terminal.
